(19) United States
(12) Patent Application Publication
(10) Pub. No.: US 2017/0105572 A1
(43) Pub. Date: Apr. 20, 2017

(54) ADVERTISING ON AN OVEN'S VIDEO DISPLAY

(71) Applicant: Geniuss Inc., Encino, CA (US)

(72) Inventors: Mehran MATLOUBIAN, Encino, CA (US); Gregg A. HOLLINGSWORTH, Tempe, AZ (US); Timothy J. BROCKETT, Malibu, CA (US)

(21) Appl. No.: 15/293,169

(22) Filed: Oct. 13, 2016

Related U.S. Application Data
(60) Provisional application No. 62/241,293, filed on Oct. 14, 2015.

(51) Int. Cl. A47J 37/06; F24C 7/08; H05B 6/80

(52) U.S. Cl. CPC A47J 37/0664; H05B 6/80; F24C 7/082

(57) ABSTRACT

Most ovens have a window on the door of the oven to allow the user/consumer to see the food inside of the oven while the food is being heated or cooked. By replacing this window with a video screen (flat panel display) and using one or more cameras that is/are pointing inside the oven, the user can view the food on the video screen instead of through the window. Addition of the video screen to the oven as well as adding a computer/microprocessor with connection to internet, and given the typical user/consumer desire to look at the display to see the food being heated or cooked, allows a good medium to present advertising to the user/consumer.

### CROSS-REFERENCES TO RELATED APPLICATIONS

This application claims priority to U.S. Provisional Patent Application No. 62/241,293, filed Oct. 14, 2015, entitled “ADVERTISING on an OVEN′S VIDEO DISPLAY” by inventors MEHRAN MATLOUBIAN, et al., commonly assigned and incorporated by reference herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

As consumers habits have been changing over the past few years by watching less broadcast TV and reading less print magazines and newspapers, advertisers have been looking for alternative approaches and mediums to present advertisements to the consumers. Advertisements have been transitioning from traditional mediums to new mediums such as online advertising when consumers do internet searches using their computers or on the consumers' cell phones.

Consumers typically spend a few hours a day at home in their kitchens so techniques that allow advertisers to reach them in a “captive” setting particularly based on the consumer's shopping habits is highly desirable.

### BRIEF SUMMARY OF THE INVENTION

Most households in developed countries have at least one oven in the kitchen of their home. They typically have a convection oven or a microwave oven or sometimes both. The ovens have a window to allow the user/consumer to see the food inside of the oven while the food is being heated or cooked. The oven's window can be replaced with a video display (flat panel display), or preferably a touch sensitive video display, connected to a video camera (or cameras) pointing into the oven to show the video of the food at one or more angles on the display. The user/customer can then watch the food inside the oven on the oven's video display instead of through an oven window or on a remote device such as a cell phone or tablet computer through wireless transmission using an integrated WiFi transceiver in the oven. This will allow the customer to monitor the progress of the food and stop or change the settings of the oven locally or remotely. The video display on the oven or remote device, combined by the desire or the need of the user/consumer to view the food in the oven provides an ideal medium to provide advertisements to the consumer. These advertisements are not limited to only when the food is in the oven and can be tailored and presented under different scenarios to the user/consumer.

The oven with the video display described above will also be connected to the internet. The internet connection can be either via a wireless connection such as WiFi or wired connection such as Ethernet or Powerline. The customer owning one of these ovens can sign up and register their oven online in order to receive software updates for his/her oven or to download recipes or oven programs for cooking specific foods with the oven. Each oven will be uniquely identifiable on the internet. The advertising on the oven video display can be based on many factors including, but not limited to, the profile of the customer depending on the type of online or in store purchases, the foods being heated or cooked in the oven, cooking programs used, recipes downloaded, the location of the house, or any combination of the aforementioned. The advertisement can be in the form of a banner advertisement at the bottom of the video display while the video display is showing the video of the food inside of the oven or can be in the form of split screen or multi-windows with one window showing the food and another window showing the advertisements or it can be a short video. Advertisements can be, but not limited to, direct advertising, links to webpages or product announcements, or coupons/discounts. Alternatively the advertising can be based on the location of the customer by advertising local products and stores, or coupons for stores nearby the location of the customer. The customer will also have the option of adding the advertised products to a shopping cart or a shopping list to be purchased later or purchase the product immediately for delivery to home. In case of coupons, they can be forwarded to the user's phone/computer, sent to an email address, or directly printed.

The video display on the oven can also be used as a “billboard” for advertising even when the oven is not in use. When the oven is not in use and no one is nearby, the oven can switch to a “sleep” mode in which only a clock and the date for example is displayed on the screen. By having a motion sensor or proximity sensor built into the oven, it can detect if someone is nearby. Or alternatively the oven can detect if someone is nearby based on the Bluetooth in the individuals, phone, watch, or wrist band (if the Bluetooth is paired with the Bluetooth in the oven). Once the oven detects that someone is nearby, it can switch the video display to a multi-window display where, for example, one window displays the clock and weather, another window displays the control buttons/tiles for the oven and another window can display advertisements or coupons. The consumer will have the option to configure or customize the display features based on their own preferences.

In another embodiment, a smaller touch sensitive video display replaces the typical control panel of the oven instead of using a larger video display covering the window of the oven. One or more cameras can still show the video of the food inside of the oven on the smaller video display. The window of the oven can stay as it is or it can be eliminated completely. The smaller video display can have similar functions to the larger display including displaying advertisements both while the food is in the oven and when it detects someone is in the proximity of the oven. The video of the food can be streamed to the customer's phone/computer with the customer having the capability to remotely control the oven.

In another embodiment a large video display can replace the window of the oven while a second display replaces the typical control panel of the oven. The two displays can be used in conjunction to control the oven, display the video of the food inside of the oven, display advertisements, provide coupons, show cooking videos, display food recipes, store and view shopping lists, or any combination of these. Advertisements can be displayed in the form of banner ads while the customer is watching cooking videos or the advertisement can be shown in a separate window on the display.

### BRIEF DESCRIPTION OF THE DRAWINGS

A more complete understanding of the present invention and its advantages will be gained from a consideration of the following description of preferred embodiments, read in conjunction with the accompanying drawings provided herein. In the figures and description, numerals indicate various features of the invention, and like numerals referring to like features throughout both the drawings and the description.

FIG. 1 is a drawing of an oven in which the window in the door of the oven is replaced with a tablet computer or flat panel display.

FIG. 2 is a drawing of an oven in which a smaller tablet computer than the one in FIG. 1 (a mini tablet computer or a “phablet”) replaces the typical controls or control panel of the oven.

FIG. 3 is a drawing of an oven in which a video camera and an infrared/thermal camera are pointing into the oven.

FIG. 4 is a drawing of an embodiment of this invention in which the video of the food inside the oven is displayed on the video display and at the bottom of the display a banner advertisement is displayed.

FIG. 5 is a drawing of another embodiment of this invention in which the video of the food inside the microwave oven is displayed as a small window on the video display that is displaying an advertisement on the video display.

FIG. 6 is a drawing of another embodiment of this invention in which the video display has multiple-windows (regions of display) with one window/region showing time, date, and weather, another window/region displaying the controls of the oven, and another window/region displaying advertisement and/or coupons.

### DETAILED DESCRIPTION OF THE INVENTION

The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. While most of the figures are of microwave ovens other types of ovens can be used as well including but not limited to convection ovens, combination convection ovens and microwave ovens, air fryers, combination air fryers, toaster ovens, and microwave ovens.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object. Additionally, the terms “first” and “second” or other like descriptors do not necessarily imply an order, but should be interpreted using ordinary meaning.

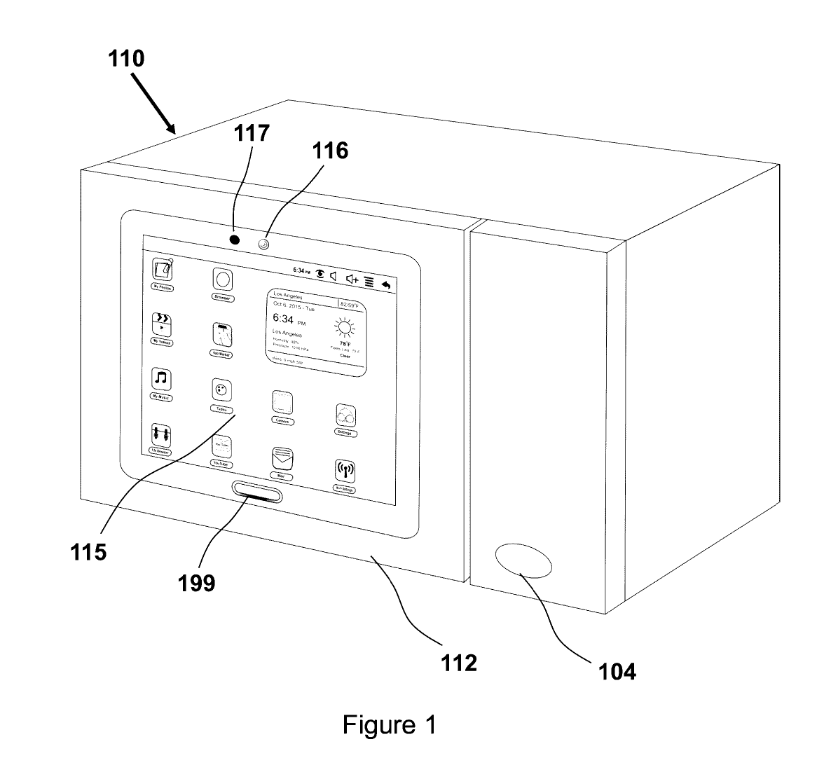

FIG. 1 is a drawing of one embodiment of this invention in which a tablet computer or flat panel display 115 replaces the window in the door 112 of the microwave oven 110. The oven door is opened using a push button 104. The video display which is also touch sensitive has a built in camera 116 (pointing outward) and a proximity sensor 117. The video display in addition has a Home or reset button 199. By adding WiFi, Bluetooth, cell phone transceiver, TV, cable, and radio tuner to the microwave oven that it is integrated with a tablet computer it is possible to have many added functionalities. The oven is connected to the internet either via a wireless connection such as WiFi or a wired connection such as Ethernet or Powerline. The oven also has a camera pointing into the microwave oven that allows the food in the oven to be displayed on the video screen. This display in addition to being used for entertainment or showing video of the food while it is being heated or cooked in the oven, it is used to show advertisements to the user (customer) in different formats including but not limited to banner advertisements, videos, and posters. The advertisements can be based on many factors including location of the oven, users shopping record and eating habits of the user and/or the household. The user/customer can add the advertised product to an electronic shopping cart to be purchased at a later date or can order the product advertised immediately online using the touch sensitive video display interface.

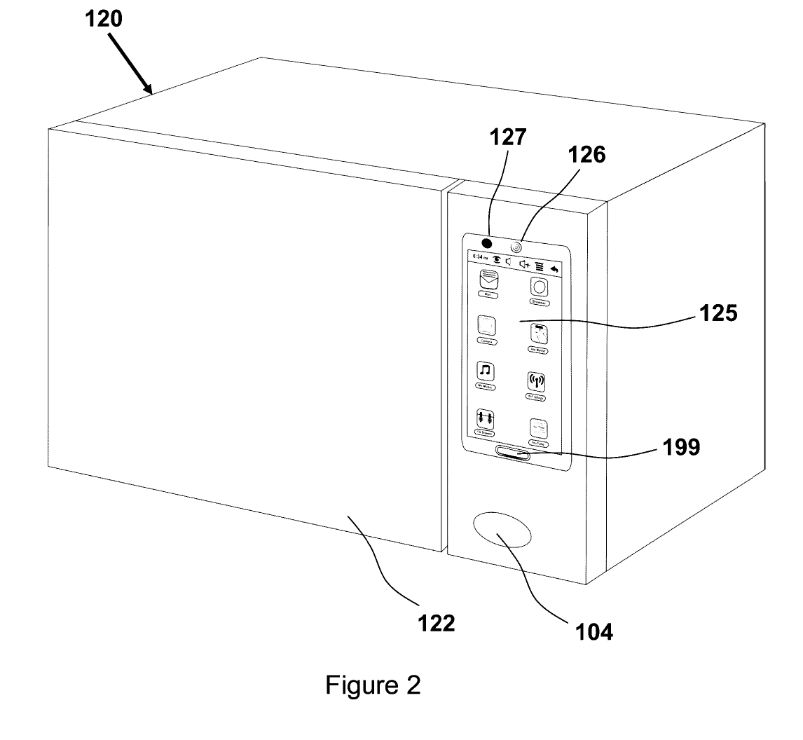

FIG. 2 is a drawing of another embodiment of this invention in which a smaller tablet computer or smaller flat panel display than in FIG. 2 (a mini tablet computer or a “phablet”) 125 replaces the typical controls on the door frame of the microwave oven 120. The window on the door 122 of the microwave oven is eliminated as the food inside of the oven can be displayed on the touch sensitive video screen using a camera that is pointing into the oven. There is also a camera 126 that is pointing outwards as well as a proximity sensor 127. Similar to the previous ovens the oven door is opened using a push button 104. The video display in addition has a Home or reset button 199. Simultaneously with the video of the food inside the oven being shown on the video display, advertisements can be displayed on the video display as well. The advertisement can be in the form of a banner advertisement or a window within the window that is showing the video of the food. The user/customer that wants to monitor the progress of food being heated or cooked inside the oven will see the advertisement. The video of the food can also be transmitted wirelessly to the user/customer's cell phone or computer for remote monitoring of the food. Along with the video of the food being transmitted to the user's cell phone or computer advertisement can be transmitted as well.

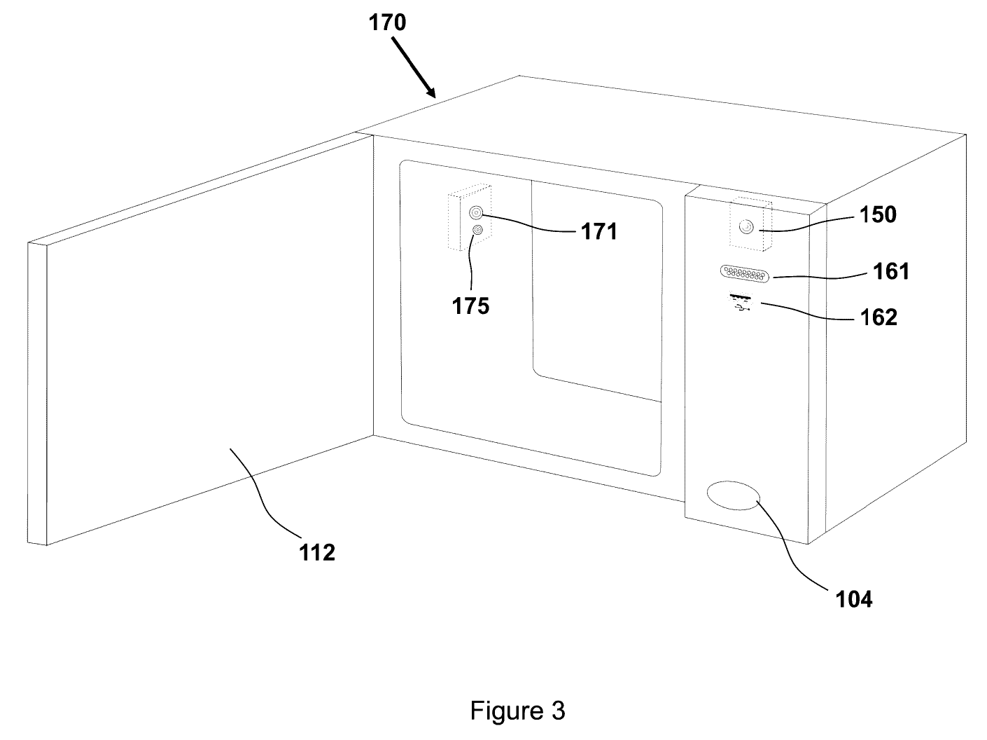

FIG. 3 is a drawing of another embodiment of this invention in which a video camera 171 and an infrared/thermal camera 175 are added pointing into the microwave oven 170. The video camera can be used to display the food while it is being heated on the video display on the door of the microwave oven 112. The infrared/thermal camera can display the temperature profile of the food and can be used to determine when the food is ready.

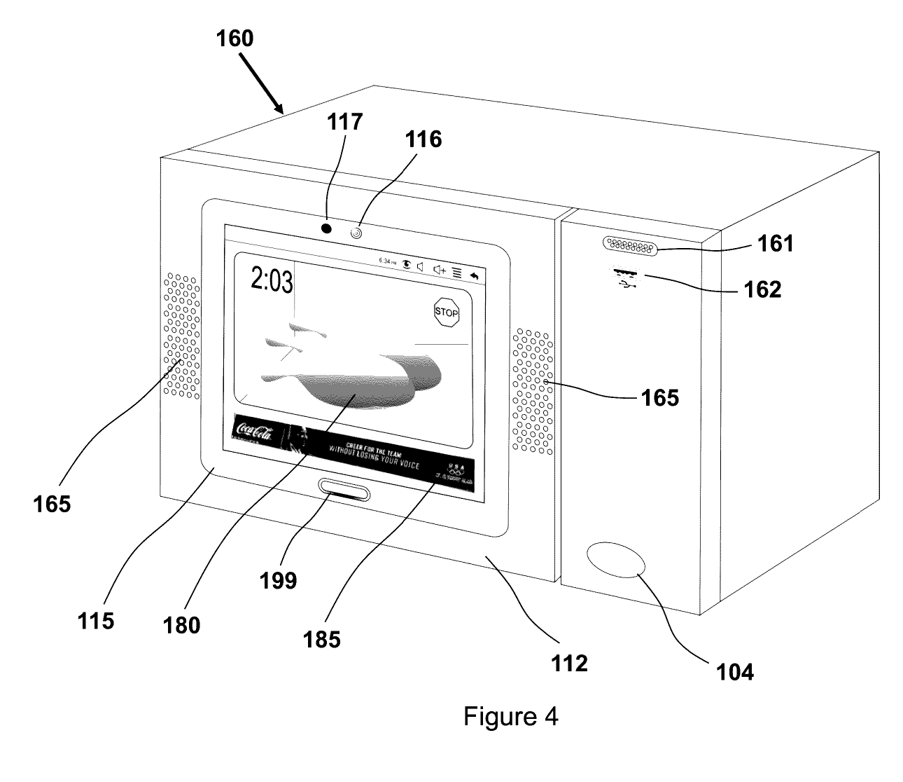

FIG. 4 is a drawing of another embodiment of this invention in which the video of the food 180 inside the microwave oven 160 is displayed on the video display 115 and at the bottom of the display a banner advertisement 185 is displayed. This banner advertisement can be based on a number of different parameters including, but not limited to, the shopping or eating habits of the user, location of the user, on the food being heated in the microwave oven or products that compliment it. Instead of banner advertisement coupons or product discounts can be presented to the user. The user can have the option to add the advertised product to an electronic shopping cart to be purchased at a later date or can order the product advertised immediately online using the touch sensitive video display interface. As mentioned above the video of the food along with the advertisement can also be wirelessly transmitted to the user's cell phone or computer for remote monitoring of the food as it is being heated or cooked. In addition to the video display integrated with the door of the oven 112, the oven has integrated speakers 165, a microphone 161, a USB port 162, outward facing camera 116, a proximity sensor 117, and Home/reset button 199.

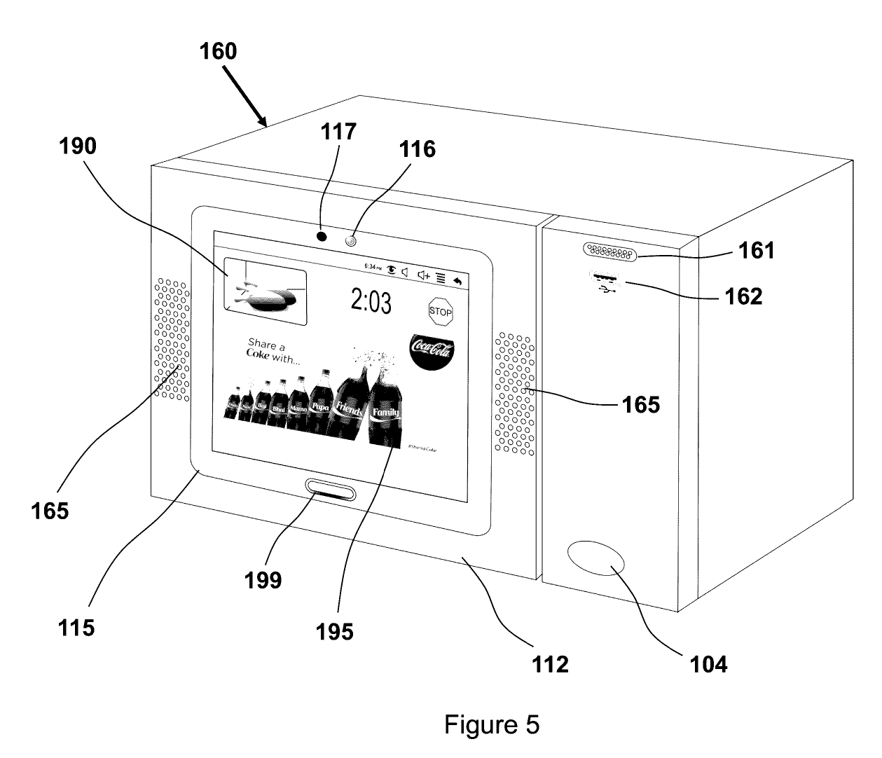

FIG. 5 is a drawing of another embodiment of this invention in which the video of the food 190 inside of the microwave oven 160 is displayed as a small window on the touch sensitive video display 115 which is also displaying a larger advertisement 195 on the video display. The user/customer can have the option to change his/her preferences regarding how the advertisements are displayed.

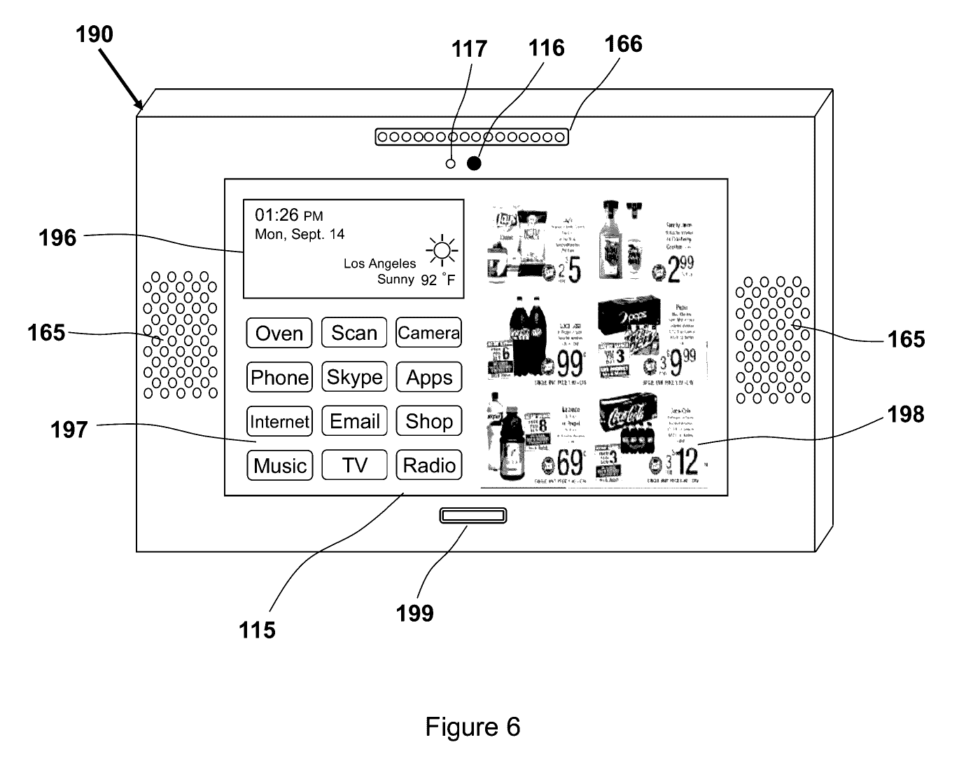

FIG. 6 is a drawing of another embodiment of this invention in which the touch sensitive video display 115 on the door 190 of an oven shows in a window/region 196 of the display the time and weather, in another window/region of the display 197 it displays icons/tiles for various functions of the appliance (oven-tablet computer/display), and in another window/region of the display it shows advertisement 198. The oven has a motion sensor 117, an outward facing camera 116, speakers 165, a microphone 166, and a Home/reset button 199. In this drawing the door of the oven is only shown. The oven also has an inward facing camera that is not shown.

What is claimed is:

1. An oven integrated with a tablet computer or a touch sensitive video display wherein the video display or tablet computer covers at least partially the door of the oven or is integrated as part of the door of the oven. The oven has Wifi or other wireless or wired method for connecting to the internet either directly or through networking with other devices or appliances and the video display of the oven is used to display advertisement.

2. The oven of claim 1 wherein the oven is a convection oven or a microwave oven or a toaster oven, or a combination of two or more types of ovens.

3. The oven of claim 1 wherein the oven is a combination of one or more types of cooking apparatuses.

4. The oven of claim 1 wherein a camera is integrated with the oven to display the picture or video of the food or drink inside the oven, while the food or drink is being heated or cooked, on the oven's display simultaneously with advertisement in the form of a video, banner ad, using multiple windows, or other types of advertisement.

5. The oven of claim 1 wherein the product or products presented in the advertisement can be purchased immediately online, added to a shopping cart to be purchased later, or added to a shopping list.

6. The oven of claim 1 wherein the product or products advertised on the oven's display are based on the food or drink being heated or cooked in the oven or based on the previous shopping history of the customer.

7. The oven of claim 1 wherein the video display is used to present product coupons or product information that the customer can save, print, or can send to a cell phone or a computer.

8. The oven of claim 1 wherein the advertisements that are presented are based on the location of the oven or the customer's residence.

9. The oven of claim 1 wherein the oven displays circulars from local supermarkets and stores.

10. The oven of claim 1 wherein the oven has a proximity sensor or motion sensor to detect when a person is nearby and displays advertisements on the oven's video display.

11. The oven of claim 1 wherein the oven recognizes the person in proximity of the oven through facial recognition or based on an electronic device that the person has in his possession such as the person's cell phone, watch, wrist band or other similar devices and the oven displays targeted advertising on its video display based on the person's prior shopping history, preferences, or internet searches.

12. The oven of claim 1 wherein advertisements are displayed on the oven's video display based on the show, event, or program being watched on the oven's display.

13. The oven of claim 1 wherein the oven's display can be used to shop or buy the advertised products.

14. The oven of claim 1 wherein the oven's display is used to show cooking instructions or recipes for various foods and the ingredients of the foods presented can be added to an electronic shopping cart using the oven's touchscreen display for future purchase or purchased immediately online.

15. The oven of claim 1 wherein the oven has an integrated intelligent voice assistant capable of understanding various commands and responding to questions and inquiries, including but not limited to commands for controlling the oven or other appliances, ordering food or other products, and adding products to shopping list or scheduling appointments.

16. The oven of claim 1 wherein the oven is used as the kitchen hub for controlling or networking with other appliances and internet of things in and around the house such as thermostats, security cameras, and door bells.

17. The oven of claim 1 wherein the oven is used for shopping.

18. The oven of claim 1 wherein the oven is used for ordering food or other items for delivery.

19. An oven integrated with a tablet computer or touch sensitive video display such that the video display covers substantially portion of the front panel of the oven or is integrated as part of the door of the oven. The oven has integrated cameras, speakers, microphone, and Wifi or other wireless or wired method for connecting to the internet either directly or through networking with other devices or appliances and the video display of the oven is used to display advertisement.

20. The oven in claim 19 wherein the oven is a convection oven or a microwave oven or a toaster oven, or a combination of two or more types of ovens.
